(19) United States
(12) Patent Application Publication
(10) Pub. No.: US 2012/0262079 A1
(43) Pub. Date: Oct. 18, 2012

(54) CIRCUITS AND METHODS FOR DRIVING LIGHT SOURCES

(76) Inventors: Yung-Lin LIN, Palo Alto, CA (US); Ching-Chuan KUO, Taipei (TW)

(21) Appl. No.: 13/530,935

(22) Filed: Jun. 22, 2012

Related U.S. Application Data
(63) Continuation-in-part of application No. 13/371,351, filed on Feb. 10, 2012.
Application No. 13/371,351 is a continuation-in-part of application No. 12/761,681, filed on Apr. 16, 2010.

(30) Foreign Application Priority Data
Mar. 4, 2010 (CN) 201010119888.2
Dec. 29, 2011 (CN) 201110453588.2

(51) Int. Cl. H05B 37/02

(52) U.S. Cl. 315/206; 315/223

(57) ABSTRACT

A circuit for powering a light source includes a filter, a transformer, and a controller. The filter receives an input voltage and filters the input voltage to provide a regulated voltage. The transformer converts the regulated voltage to an output voltage to power the light source. The controller generates a driving signal to alternately operate the switch between a first state and a second state. The controller corrects a power factor of the circuit by controlling time durations of the first state and the second state, such that an input current decreases to a predetermined level during the second state and increases from the predetermined level to a peak level proportional to the input voltage during the first state. The controller controls the ratio of time in the first state to time in the second state to adjust an output current flowing through the light source to a target level.

### RELATED APPLICATIONS

This application is a continuation-in-part of the co-pending U.S. application Ser. No. 13/371,351, titled “Circuits and Methods for Driving Light Sources,” filed on Feb. 10, 2012, which itself is a continuation-in-part of the co-pending U.S. application Ser. No. 12/761,681, titled “Circuits and Methods for Driving Light Sources,” filed on Apr. 16, 2010, which itself claims priority to Chinese Patent Application No. 201010119888.2, titled “Circuits and Methods for Driving Light Sources,” filed on Mar. 4, 2010, with the State Intellectual Property Office of the People's Republic of China. The application with Ser. No. 13/371,351 also claims priority to Chinese Patent Application No. 201110453588.2, titled “Circuit, Method and Controller for Driving LED Light Source,” filed on Dec. 29, 2011, with the State Intellectual Property Office of the People's Republic of China.

### BACKGROUND

FIG. 1 shows a block diagram of a conventional circuit 100 for driving a light source, e.g., a light emitting diode (LED) string 108. The circuit 100 is powered by a power source 102 which provides an input voltage VIN. The circuit 100 includes a buck converter for providing a regulated voltage VOUT to an LED string 108 under control of a controller 104. The buck converter includes a diode 114, an inductor 112, a capacitor 116, and a switch 106. A resistor 110 is coupled in series with the switch 106. When the switch 106 is turned on, the resistor 110 is coupled to the inductor 112 and the LED string 108, and can provide a feedback signal indicative of a current flowing through the inductor 112. When the switch 106 is turned off, the resistor 110 is disconnected from the inductor 112 and the LED string 108, and thus no current flows through the resistor 110.

The switch 106 is controlled by the controller 104. When the switch 106 is turned on, a current flows through the LED string 108, the inductor 112, the switch 106, and the resistor 110 to ground. The current increases due to the inductance of the inductor 112. When the current reaches a predetermined peak current level, the controller 104 turns off the switch 106. When the switch 106 is turned off, a current flows through the LED string 108, the inductor 112 and the diode 114. The controller 104 can turn on the switch 106 again after a time period. Thus, the controller 104 controls the buck converter based on the predetermined peak current level. However, the average level of the current flowing through the inductor 112 and the LED string 108 can vary with the inductance of the inductor 112, the input voltage VIN, and the voltage VOUT across the LED string 108. Therefore, the average level of the current flowing through the inductor 112 (the average current flowing through the LED string 108) may not be accurately controlled.

### SUMMARY

In one embodiment, a circuit for powering a light source includes a filter, a transformer, and a controller. The filter receives an input voltage and filters the input voltage to provide a regulated voltage. The transformer converts the regulated voltage to an output voltage to power the light source. The controller generates a driving signal to alternately operate the switch between a first state and a second state. The controller corrects a power factor of the circuit by controlling time durations of the first state and the second state, such that an input current decreases to a predetermined level during the second state and increases from the predetermined level to a peak level proportional to the input voltage during the first state. The controller controls the ratio of time in the first state to time in the second state to adjust an output current flowing through the light source to a target level.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a block diagram of a conventional circuit for driving a light source.

FIG. 2 shows a block diagram of a driving circuit, in an embodiment according to the present invention.

FIG. 3 shows an example for a schematic diagram of a driving circuit, in an embodiment according to the present invention.

FIG. 4 shows an example of the controller in FIG. 3, in an embodiment according to the present invention.

FIG. 5 shows signal waveforms of signals associated with a controller in FIG. 4, in an embodiment according to the present invention.

FIG. 6 shows another example of the controller in FIG. 3, in an embodiment according to the present invention.

FIG. 7 shows signal waveforms of signals associated with a controller in FIG. 6, in an embodiment according to the present invention.

FIG. 8 shows another example for a schematic diagram of a driving circuit, in an embodiment according to the present invention.

FIG. 9A shows another block diagram of a driving circuit, in an embodiment according to the present invention.

FIG. 9B shows an example of waveforms of signals generated or received by a driving circuit in FIG. 9A, in an embodiment according to the present invention.

FIG. 10 shows an example for a schematic diagram of a driving circuit, in an embodiment according to the present invention.

FIG. 11 shows an example of a controller in FIG. 9A, in an embodiment according to the present invention.

FIG. 12 illustrates a waveform of signals generated or received by a driving circuit, in an embodiment according to the present invention.

FIG. 13 illustrates a flowchart of operations performed by a circuit for driving a load, in an embodiment according to the present invention.

FIG. 14A shows another block diagram of a driving circuit in an embodiment according to the present invention.

FIG. 14B illustrates another waveform of signals generated or received by a driving circuit, in an embodiment according to the present invention.

FIG. 15 shows an example schematic diagram of a driving circuit, in an embodiment according to the present invention.

FIG. 16 shows an example of a controller in an embodiment according to the present invention.

FIG. 17 illustrates a flowchart of examples of operations performed by a circuit for driving a light source, in an embodiment according to the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide circuits and methods for controlling power converters that can be used to power various types of loads, for example, a light source. In one embodiment, the circuit can include a current sensor operable for monitoring a current flowing through an energy storage element, e.g., an inductor, and include a controller operable for controlling a switch coupled to the inductor so as to control an average current of the light source to a target current. The current sensor can monitor the current through the inductor when the switch is on and also when the switch is off.

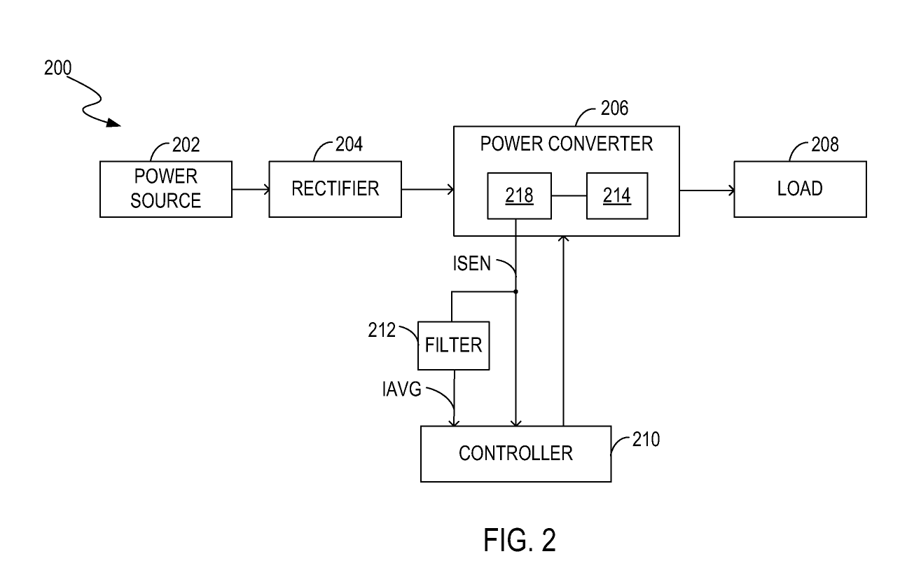

FIG. 2 shows a block diagram of a driving circuit 200, in an embodiment according to the present invention. The driving circuit 200 includes a rectifier 204 which receives an input voltage from a power source 202 and provides a rectified voltage to a power converter 206. The power converter 206, receiving the rectified voltage, provides output power for a load 208. The power converter 206 can be a buck converter or a boost converter. In one embodiment, the power converter 206 includes an energy storage element 214 and a current sensor 218 for sensing an electrical condition of the energy storage element 214. The current sensor 218 provides a first signal ISEN to a controller 210, which indicates an instant current flowing through the energy storage element 214. The driving circuit 200 can further include a filter 212 operable for generating a second signal IAVG based on the first signal ISEN, which indicates an average current flowing through the energy storage element 214. The controller 210 receives the first signal ISEN and the second signal IAVG, and controls the average current flowing through the energy storage element 214 to a target current level, in one embodiment.

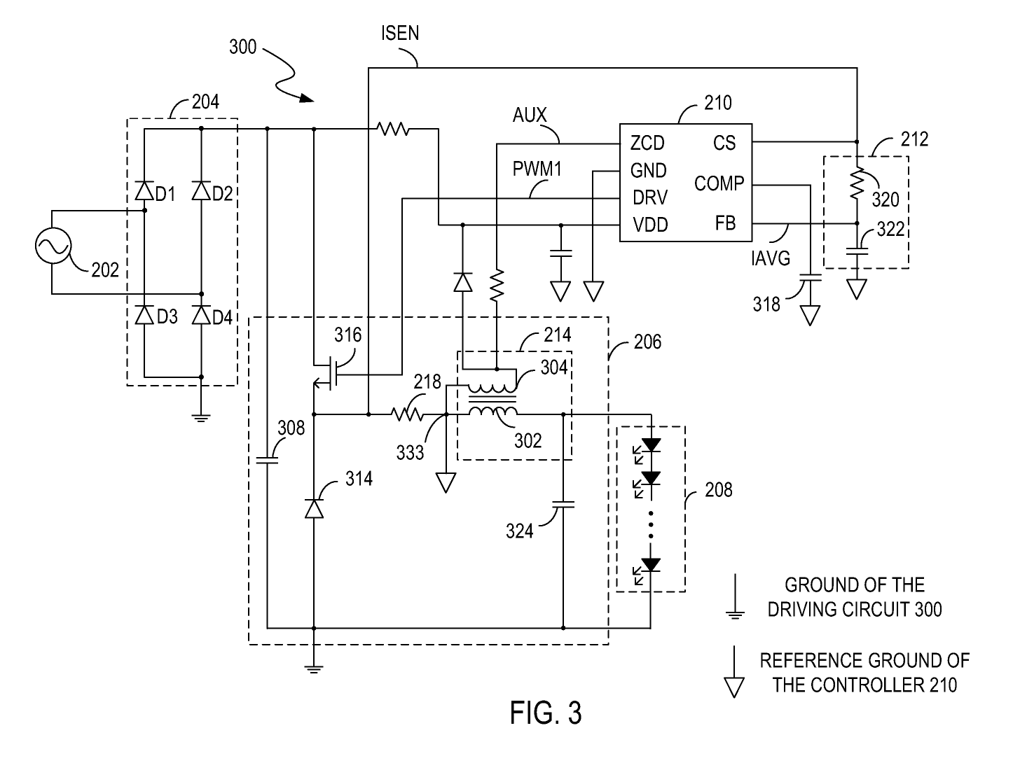

FIG. 3 shows an example for a schematic diagram of a driving circuit 300, in an embodiment according to the present invention. Elements labeled the same as in FIG. 2 have similar functions. In the example of FIG. 3, the driving circuit 300 includes a rectifier 204, a power converter 206, a filter 212, and a controller 210. By way of example, the rectifier 204 is a bridge rectifier which includes diodes D1˜D4. The rectifier 204 rectifies the voltage from the power source 202. The power converter 206 receives the rectified voltage from the rectifier 204 and provides output power for powering a load, e.g., an LED string 208.

In the example of FIG. 3, the power converter 206 is a buck converter including a capacitor 308, a switch 316, a diode 314, a current sensor 218 (e.g., a resistor), coupled inductors 302 and 304, and a capacitor 324. The diode 314 is coupled between the switch 316 and ground of the driving circuit 300. The capacitor 324 is coupled in parallel with the LED string 208. In one embodiment, the inductors 302 and 304 are both electrically and magnetically coupled together. More specifically, the inductor 302 and the inductor 304 are electrically coupled to a common node 333. In the example of FIG. 3, the common node 333 is between the resistor 218 and the inductor 302. However, the invention is not so limited; the common node 333 can also locate between the switch 316 and the resistor 218. The common node 333 provides a reference ground for the controller 210. The reference ground of the controller 210 is different from the ground of the driving circuit 300, in one embodiment. By turning the switch 316 on and off, a current flowing through the inductor 302 can be adjusted, thereby adjusting the power provided to the LED string 208. The inductor 304 senses an electrical condition of the inductor 302, for example, whether the current flowing through the inductor 302 decreases to a predetermined current level.

The resistor 218 has one end coupled to a node between the switch 316 and the cathode of the diode 314, and the other end coupled to the inductor 302. The resistor 218 provides a first signal ISEN indicating an instant current flowing through the inductor 302 when the switch 316 is on and also when the switch 316 is off. In other words, the resistor 218 can sense the instant current flowing through the inductor 302 regardless of whether the switch 316 is on or off. The filter 212 coupled to the resistor 218 generates a second signal IAVG indicating an average current flowing through the inductor 302. In one embodiment, the filter 212 includes a resistor 320 and a capacitor 322.

The controller 210 receives the first signal ISEN and the second signal IAVG, and controls an average current flowing through the inductor 302 to a target current level by turning the switch 316 on and off. A capacitor 324 absorbs ripple current flowing through the LED string 208 such that the current flowing through the LED string 208 is smoothed and substantially equal to the average current flowing through the inductor 302. As such, the current flowing through the LED string 208 can have a level that is substantially equal to the target current level. As used herein, “substantially equal to the target current level” means that the current flowing through the LED string 208 may be slightly different from the target current level but within a range such that the current ripple caused by the non-ideality of the circuit components can be neglected and the power transferred from the inductor 304 to the controller 210 can be neglected.

In the example of FIG. 3, the controller 210 has terminals ZCD, GND, DRV, VDD, CS, COMP and FB. The terminal ZCD is coupled to the inductor 304 for receiving a detection signal AUX indicating an electrical condition of the inductor 302, for example, whether the current flowing through the inductor 302 decreases to a predetermined current level, e.g., zero. The signal AUX can also indicate whether the LED string 208 is in an open circuit condition. The terminal DRV is coupled to the switch 316 and generates a driving signal, e.g., a pulse-width modulation signal PWM1, to turn the switch 316 on and off. The terminal VDD is coupled to the inductor 304 for receiving power from the inductor 304. The terminal CS is coupled to the resistor 218 and is operable for receiving the first signal ISEN indicating an instant current flowing through the inductor 302. The terminal COMP is coupled to the reference ground of the controller 210 through a capacitor 318. The terminal FB is coupled to the resistor 218 through the filter 212 and is operable for receiving the second signal IAVG which indicates an average current flowing through the inductor 302. In the example of FIG. 3, the terminal GND, that is, the reference ground for the controller 210, is coupled to the common node 333 between the resistor 218, the inductor 302, and the inductor 304.

The switch 316 can be an N channel metal oxide semiconductor field effect transistor (NMOSFET). The conductance status of the switch 316 is determined based on a difference between the gate voltage of the switch 316 and the voltage at the terminal GND (the voltage at the common node 333). Therefore, the switch 316 is turned on and turned off depending upon the pulse-width modulation signal PWM1 from the terminal DRV. When the switch 316 is on, the reference ground of the controller 210 is higher than the ground of the driving circuit 300, making the invention suitable for power sources having relatively high voltages.

In operation, when the switch 316 is turned on, a current flows through the switch 316, the resistor 218, the inductor 302, the LED string 208 to the ground of the driving circuit 300. When the switch 316 is turned off, a current continues to flow through the resistor 218, the inductor 302, the LED string 208 and the diode 314. The inductor 304 magnetically coupled to the inductor 302 detects an electrical condition of the inductor 302, for example, whether the current flowing through the inductor 302 decreases to a predetermined current level. Therefore, the controller 210 monitors the current flowing through the inductor 302 through the signal AUX, the signal ISEN, and the signal IAVG, and control the switch 316 by a pulse-width modulation signal PWM1 so as to control an average current flowing through the inductor 302 to a target current level, in one embodiment. As such, the current flowing through the LED string 208, which is filtered by the capacitor 324, can also be substantially equal to the target current level.

In one embodiment, the controller 210 determines whether the LED string 208 is in an open circuit condition based on the signal AUX. If the LED string 208 is open, the voltage across the capacitor 324 increases. When the switch 316 is off, the voltage across the inductor 302 increases and the voltage of the signal AUX increases accordingly. As a result, the current flowing through the terminal ZCD into the controller 210 increases. Therefore, the controller 210 monitors the signal AUX and if the current flowing into the controller 210 increases above a current threshold when the switch 316 is off, the controller 210 determines that the LED string 208 is in an open circuit condition.

The controller 210 can also determine whether the LED string 208 is in a short circuit condition based on the voltage at the terminal VDD. If the LED string 208 is in a short circuit condition, when the switch 316 is off, the voltage across the inductor 302 decreases because both terminals of the inductor 302 are coupled to ground of the driving circuit 300. The voltage across the inductor 304 and the voltage at the terminal VDD decrease accordingly. If the voltage at the terminal VDD decreases below a voltage threshold when the switch 316 is off, the controller 210 determines that the LED string 208 is in a short circuit condition.

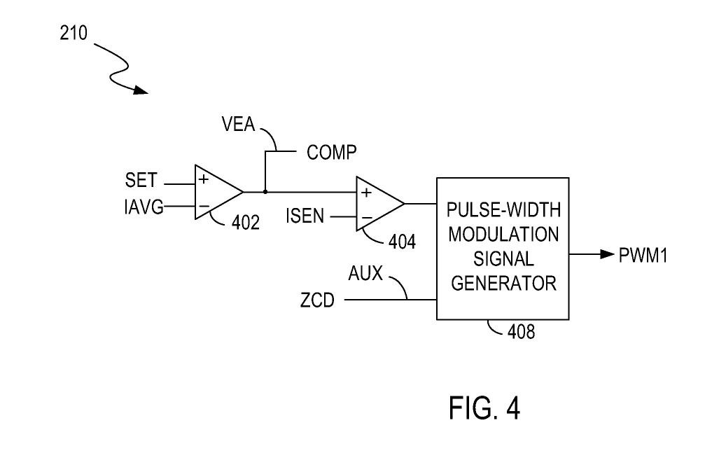

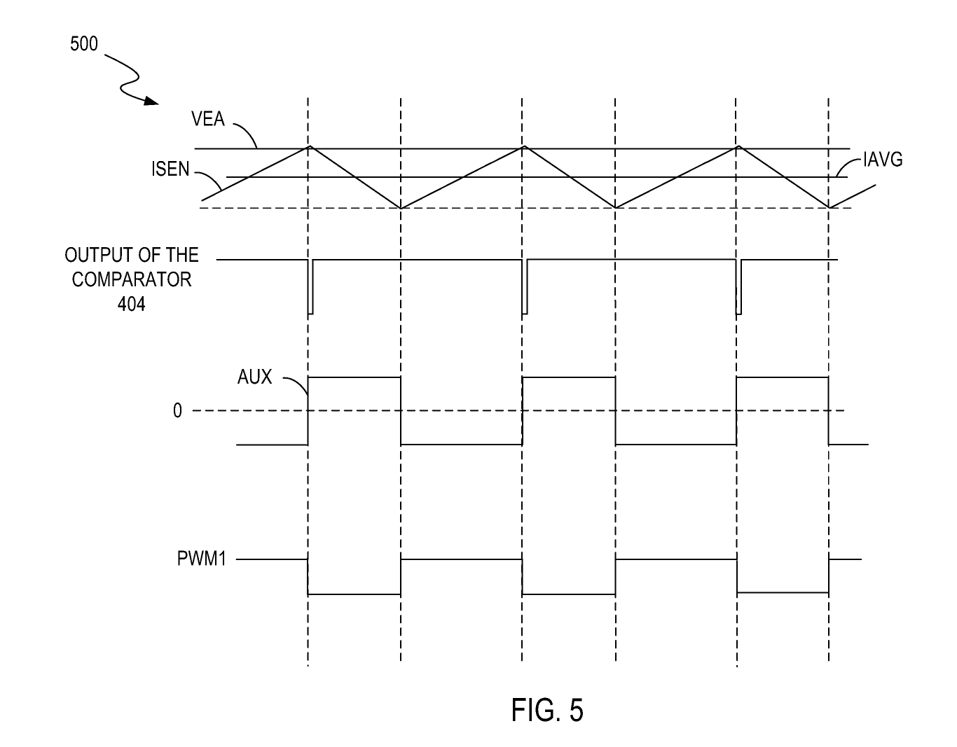

FIG. 4 shows an example of the controller 210 in FIG. 3, in an embodiment according to the present invention. FIG. 5 shows signal waveforms of signals associated with the controller 210 in FIG. 4, in an embodiment according to the present invention. FIG. 4 is described in combination with FIG. 3 and FIG. 5.

In the example of FIG. 4, the controller 210 includes an error amplifier 402, a comparator 404, and a pulse-width modulation signal generator 408. The error amplifier 402 generates an error signal VEA based on a difference between a reference signal SET and the signal IAVG. The reference signal SET can indicate a target current level. The signal IAVG is received at the terminal FB and can indicate an average current flowing through the inductor 302. The error signal VEA can be used to adjust the average current flowing through the inductor 302 to the target current level. The comparator 404 is coupled to the error amplifier 402 and compares the error signal VEA with the signal ISEN. The signal ISEN is received at the terminal CS and indicates an instant current flowing through the inductor 302. The signal AUX is received at the terminal ZCD and indicates whether the current flowing through the inductor 302 decreases to a predetermined current level, e.g., zero. The pulse-width modulation signal generator 408 is coupled to the comparator 404 and the terminal ZCD, and can generate a pulse-width modulation signal PWM1 based on an output of the comparator 404 and the signal AUX. The pulse-width modulation signal PWM1 is applied to the switch 316 via the terminal DRV to control a conductance status of the switch 316.

In operation, the pulse-width modulation signal generator 408 can generate the pulse-width modulation signal PWM1 having a first level (e.g., logic 1) to turn on the switch 316. When the switch 316 is turned on, a current flows through the switch 316, the resistor 218, the inductor 302, the LED string 208 to the ground of the driving circuit 300. The current flowing through the inductor 302 increases such that the voltage of the signal ISEN increases. The signal AUX has a negative voltage level when the switch 316 is turned on, in one embodiment. In the controller 210, the comparator 404 compares the error signal VEA with the signal ISEN. When the voltage of the signal ISEN increases above the voltage of the error signal VEA, the output of the comparator 404 is logic 0, otherwise the output of the comparator 404 is logic 1, in one embodiment. In other words, the output of the comparator 404 includes a series of pulses. The pulse-width modulation signal generator 408 generates the pulse-width modulation signal PWM1 having a second level (e.g., logic 0) in response to a negative-going edge of the output of the comparator 404 to turn off the switch 316. The voltage of the signal AUX changes to a positive voltage level when the switch 316 is turned off. When the switch 316 is turned off, a current flows through the resistor 218, the inductor 302, the LED string 208 and the diode 314. The current flowing through the inductor 302 decreases such that the voltage of the signal ISEN decreases. When the current flowing through the inductor 302 decreases to a predetermined current level (e.g., zero), a negative-going edge occurs to the voltage of the signal AUX. Receiving a negative-going edge of the signal AUX, the pulse-width modulation signal generator 408 generates the pulse-width modulation signal PWM1 having the first level (e.g., logic 1) to turn on the switch 316.

In one embodiment, a duty cycle of the pulse-width modulation signal PWM1 is determined by the error signal VEA. If the voltage of the signal IAVG is less than the voltage of the signal SET, the error amplifier 402 increases the voltage of the error signal VEA so as to increase the duty cycle of the pulse-width modulation signal PWM1. Accordingly, the average current flowing through the inductor 302 increases until the voltage of the signal IAVG reaches the voltage of the signal SET. If the voltage of the signal IAVG is greater than the voltage of the signal SET, the error amplifier 402 decreases the voltage of the error signal VEA so as to decrease the duty cycle of the pulse-width modulation signal PWM1. Accordingly, the average current flowing through the inductor 302 decreases until the voltage of the signal IAVG drops to the voltage of the signal SET. As such, the average current flowing through the inductor 302 can be maintained to be substantially equal to the target current level.

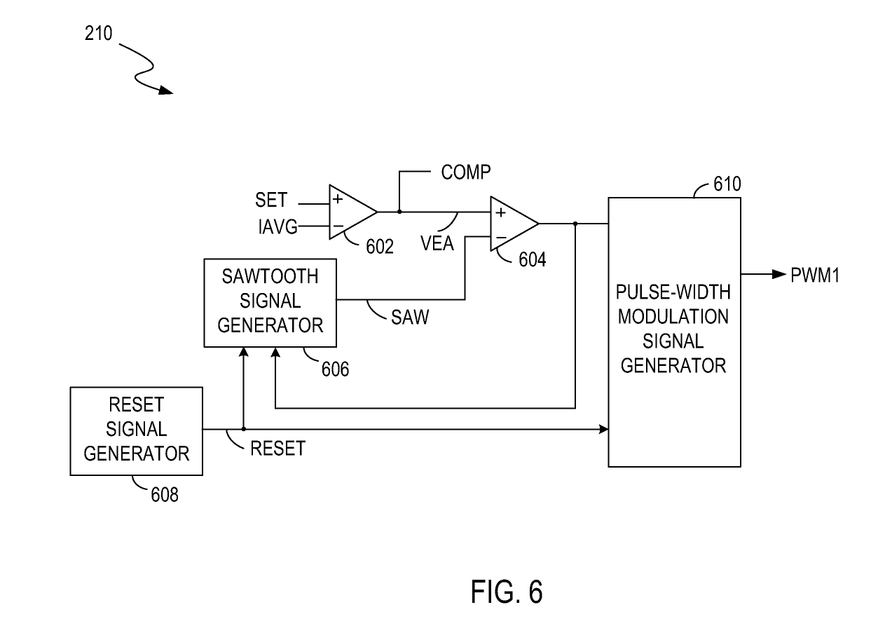

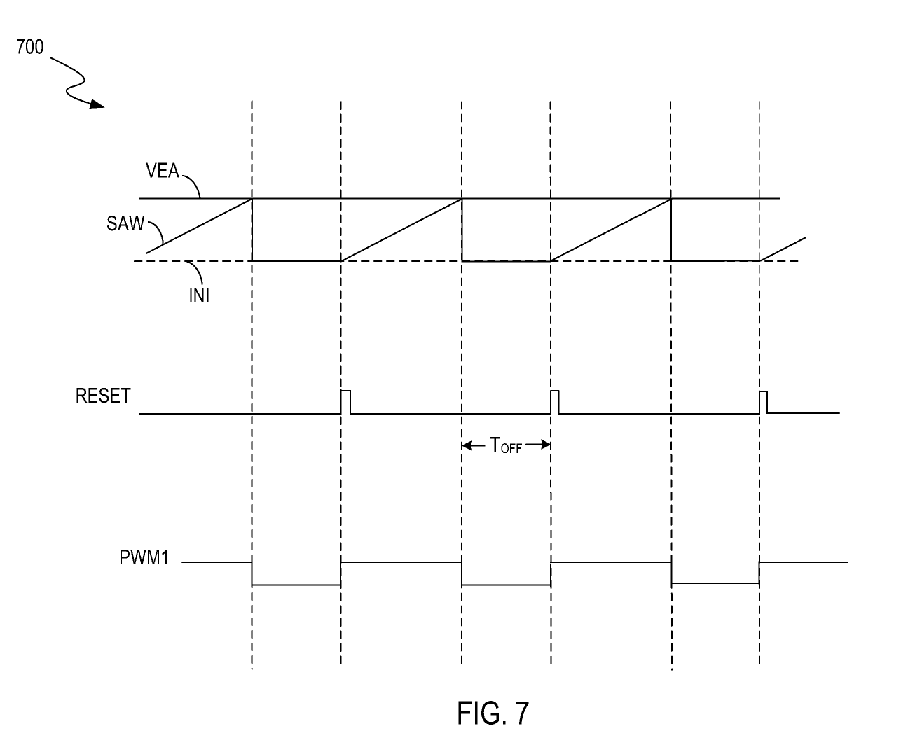

FIG. 6 shows another example of the controller 210 in FIG. 3, in an embodiment according to the present invention. FIG. 7 shows waveforms of signals associated with the controller 210 in FIG. 6, in an embodiment according to the present invention. FIG. 6 is described in combination with FIG. 3 and FIG. 7.

In the example of FIG. 6, the controller 210 includes an error amplifier 602, a comparator 604, a saw-tooth signal generator 606, a reset signal generator 608, and a pulse-width modulation signal generator 610. The error amplifier 602 generates an error signal VEA based on a reference signal SET and the signal IAVG. The reference signal SET indicates a target current level. The signal IAVG is received at the terminal FB and indicates an average current flowing through the inductor 302. The error signal VEA is used to adjust the average current flowing through the inductor 302 to the target current level. The saw-tooth signal generator 606 generates a saw-tooth signal SAW. The comparator 604 is coupled to the error amplifier 602 and the saw-tooth signal generator 606, and compares the error signal VEA with the saw-tooth signal SAW. The reset signal generator 608 generates a reset signal RESET which is applied to the saw-tooth signal generator 606 and the pulse-width modulation signal generator 610. The switch 316 can be turned on in response to the reset signal RESET. The pulse-width modulation signal generator 610 is coupled to the comparator 604 and the reset signal generator 608, and generates a pulse-width modulation (PWM) signal PWM1 based on an output of the comparator 604 and the reset signal RESET. The pulse-width modulation signal PWM1 is applied to the switch 316 via the terminal DRV to control a conductance status of the switch 316.

In one embodiment, the reset signal RESET is a pulse signal having a constant frequency. In another embodiment, the reset signal RESET is a pulse signal configured in a way such that a time period Toff during which the switch 316 is off is constant. For example, in FIG. 5, the time period during which the pulse-width modulation signal PWM1 is logic 0 can be constant.

In operation, the pulse-width modulation signal generator 610 generates the pulse-width modulation signal PWM1 having a first level (e.g., logic 1) to turn on the switch 316 in response to a pulse of the reset signal RESET. When the switch 316 is turned on, a current flows through the switch 316, the resistor 218, the inductor 302, the LED string 208 to the ground of the driving circuit 300. The saw-tooth signal SAW generated by the saw-tooth signal generator 606 starts to increase from an initial level INI in response to a pulse of the reset signal RESET. When the voltage of the saw-tooth signal SAW increases to the voltage of the error signal VEA, the pulse-width modulation signal generator 610 generates the pulse-width modulation signal PWM1 having a second level (e.g., logic 0) to turn off the switch 316. The saw-tooth signal SAW is reset to the initial level INI until a next pulse of the reset signal RESET is received by the saw-tooth signal generator 606. The saw-tooth signal SAW starts to increase from the initial level INI again in response to the next pulse.

In one embodiment, a duty cycle of the pulse-width modulation signal PWM1 is determined by the error signal VEA. If the voltage of the signal IAVG is less than the voltage of the signal SET, the error amplifier 602 increases the voltage of the error signal VEA so as to increase the duty cycle of the pulse-width modulation signal PWM1. Accordingly, the average current flowing through the inductor 302 increases until the voltage of the signal IAVG reaches the voltage of the signal SET. If the voltage of the signal IAVG is greater than the voltage of the signal SET, the error amplifier 602 decreases the voltage of the error signal VEA so as to decrease the duty cycle of the pulse-width modulation signal PWM1. Accordingly, the average current flowing through the inductor 302 decreases until the voltage of the signal IAVG drops to the voltage of the signal SET. As such, the average current flowing through the inductor 302 can be maintained to be substantially equal to the target current level.

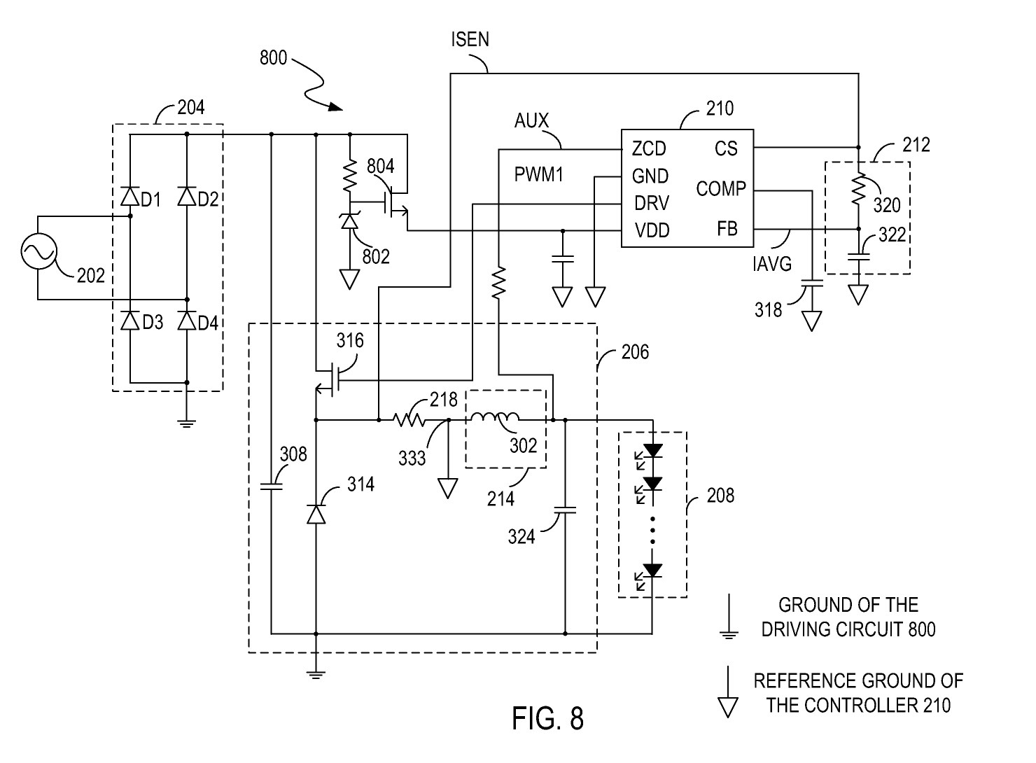

FIG. 8 shows another example for a schematic diagram of a driving circuit 800, in an embodiment according to the present invention. Elements labeled the same as in FIG. 2 and FIG. 3 have similar functions.

The terminal VDD of the controller 210 is coupled to the rectifier 204 through a switch 804 for receiving the rectified voltage from the rectifier 204. A Zener diode 802 is coupled between the switch 804 and the reference ground of the controller 210, and maintains the voltage at the terminal VDD at a substantially constant level. In the example of FIG. 8, the terminal ZCD of the controller 210 is electrically coupled to the inductor 302 for receiving a signal AUX indicating an electrical condition of the inductor 302, e.g., whether the current flowing through the inductor 302 decreases to a predetermined current level, e.g., zero. The node 333 can provide the reference ground for the controller 210.

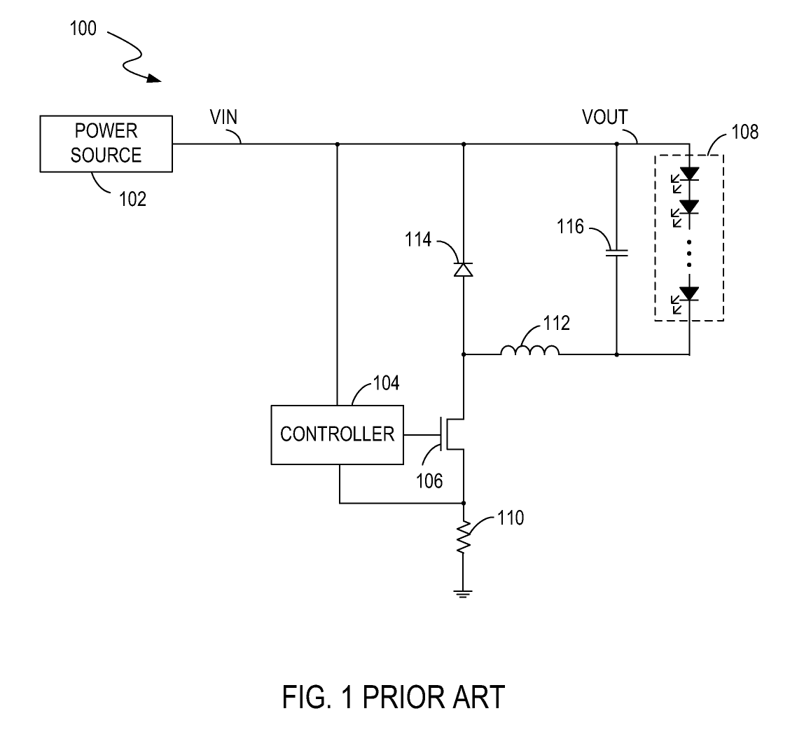

Accordingly, embodiments in accordance with the present invention provide circuits and methods for controlling a power converter that can be used to power various types of loads. In one embodiment, the power converter provides a substantially constant current to power a load such as a light emitting diode (LED) string. In another embodiment, the power converter provides a substantially constant current to charge a battery. Advantageously, compared with the conventional driving circuit in FIG. 1, the average current to the load or the battery can be controlled more accurately. Furthermore, the circuits according to present invention can be suitable for power sources having relatively high voltages.

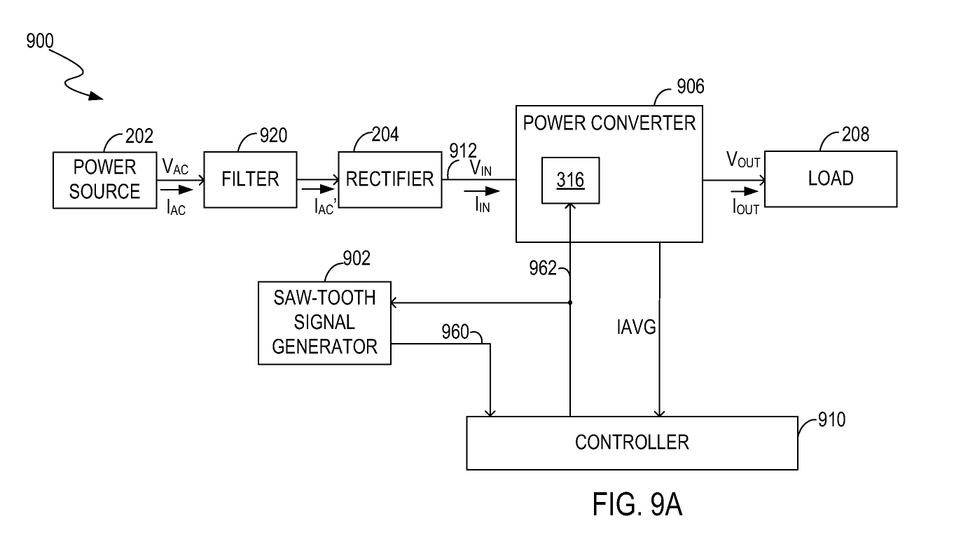

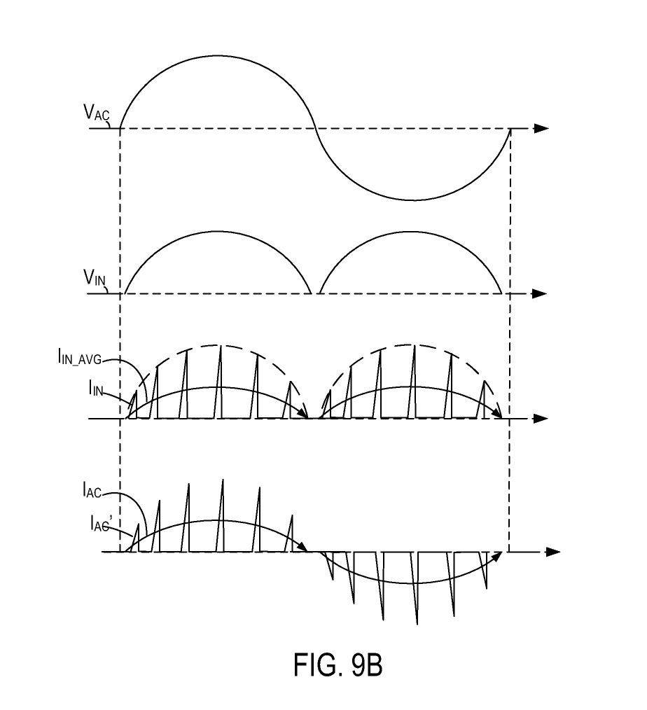

FIG. 9A shows another block diagram of a driving circuit 900, in an embodiment according to the present invention. Elements labeled the same as in FIG. 2 and FIG. 3 have similar functions. In the example of FIG. 9A, the driving circuit 900 includes a current filter 920 coupled to a power source 202, a rectifier 204, a power converter 906, a load 208, a saw-tooth signal generator 902, and a controller 910. The power source 202 generates an AC input voltage V_{AC}, e.g., having a sinusoidal waveform, and an AC input current I_{AC}. The AC input current I_{AC} flows into the current filter 920 and a current I_{AC}′ flows from the current filter 920 to the rectifier 204. The rectifier 204 receives the AC input voltage V_{AC} via the current filter 920 and provides a rectified AC voltage V_{IN} and a rectified AC current I_{IN} at the power line 912 coupled between the rectifier 204 and the power converter 906. The power converter 906 converts the voltage V_{IN} to an output voltage V_{OUT} to power the load 208. The controller 910 coupled to the power converter 906 controls the power converter 906 to regulate a current I_{OUT} through the load 208 and correct a power factor of the driving circuit 900.

The controller 910 generates a driving signal 962. In one embodiment, the power converter 906 includes a switch 316 which is controlled by the driving signal 962. As such, a current I_{OUT} flowing through the load 208 is regulated according to the driving signal 962. In one embodiment, the power converter 906 further generates a sense signal IAVG indicating the current I_{OUT} through the load 208.

In one embodiment, the saw-tooth signal generator 902 coupled to the controller 910 generates a saw-tooth signal 960 according to the driving signal 962. For example, the driving signal 962 can be a pulse-width modulation (PWM) signal. In one embodiment, when the driving signal 962 is logic high, the saw-tooth signal 960 is increased; when the driving signal 962 is logic low, the saw-tooth signal 960 drops to a predetermined voltage level, e.g., zero volt.

Advantageously, the controller 910 generates the driving signal 962 based on signals including the saw-tooth signal 960 and the sense signal IAVG. The driving signal 962 controls the switch 316 to maintain the current I_{OUT} through the load 208 at a target level, which improves the accuracy of the current control. In addition, the driving signal 962 controls the switch 316 to adjust an average current I_{IN}_{_{—}}_{AVG} of the current I_{IN} to be substantially in phase with the input voltage V_{IN}, which corrects a power factor of the driving circuit 900. The operation of the driving circuit 900 is further described in FIG. 9B.

FIG. 9B shows an example of waveforms of signals associated with the driving circuit 900 in FIG. 9A, in an embodiment according to the present invention. FIG. 9B is described in combination with FIG. 9A. FIG. 9B shows the input AC voltage V_{AC}, the rectified AC voltage V_{IN}, the rectified AC current I_{IN}, the current I_{AC}′, and the input AC current I_{AC}.

For illustrative purposes but not limitation, the input AC voltage V_{AC} has a sinusoidal waveform. The rectifier 204 rectifies the input AC voltage V_{AC}. In the example of FIG. 9B, the rectified AC voltage V_{IN} has a rectified sinusoidal waveform, in which positive waves of the input AC voltage V_{AC} remains and negative waves of the input AC voltage V_{AC} is converted to corresponding positive waves.

In one embodiment, the driving signal 962 generated by the controller 910 controls the current I_{IN}. In one embodiment, the current I_{IN} increases from a predetermined level, e.g., zero ampere. After the current I_{IN} reaches a level proportional to the rectified input AC voltage V_{IN}, the current I_{IN} drops to the predetermined level. Thus, as shown in FIG. 9B, the waveform of the average current I_{IN}_{_{—}}_{AVG} of the current I_{IN} is substantially in phase with the waveform of the rectified AC voltage V_{IN}.

The current I_{IN} flowing from the rectifier 204 to the power converter 906 is a rectified current of the current I_{AC}′ flowing into the rectifier 204.

As shown in FIG. 9B, the current I_{AC}′ has positive waves similar to those of the current I_{IN} when the input AC voltage V_{AC} is positive and has negative waves corresponding to those of the current I_{IN} when the input AC voltage V_{AC} is negative.

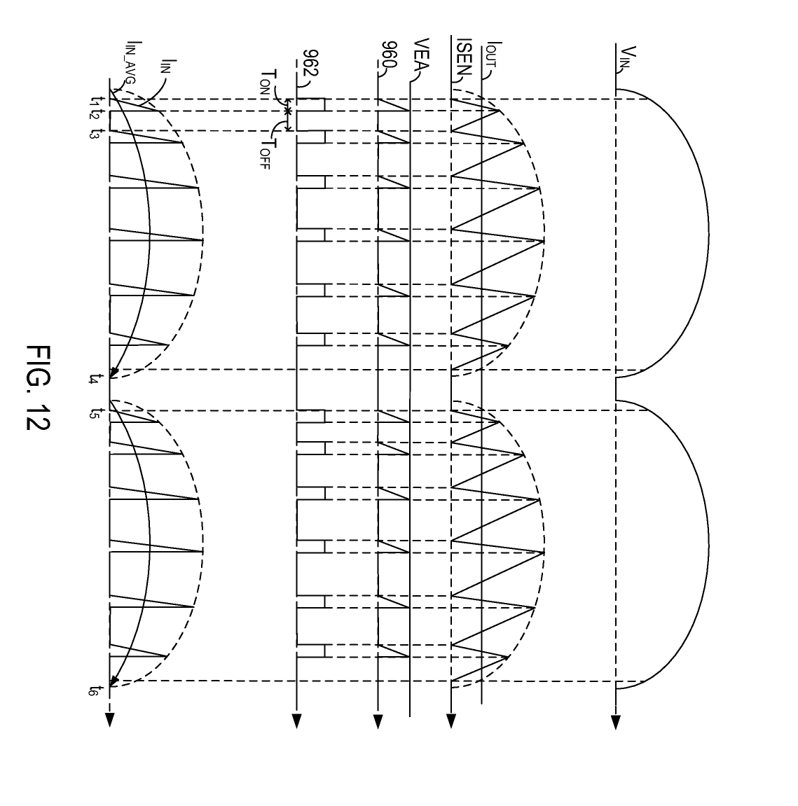

In one embodiment, by employing a current filter 920 between the power source 202 and the rectifier 204, the input AC current I_{AC} is equal to or proportional to an average current of the current I_{AC}′. Therefore, as shown in FIG. 12, the waveform of the input AC current I_{AC} is substantially in phase with the waveform of the input AC voltage V_{AC}. Ideally, the AC input voltage V_{AC} and the AC input current I_{AC} are in phase. However, in practical application, there might be a slight phase difference due to capacitors in the current filter 920 and the power converter 906. Moreover, the shape of the waveform of the input AC current I_{AC} is similar to the shape of the waveform of the input AC voltage V_{AC}. Therefore, a power factor of the driving circuit 900 is corrected, which improves the power quality of the driving circuit 900.

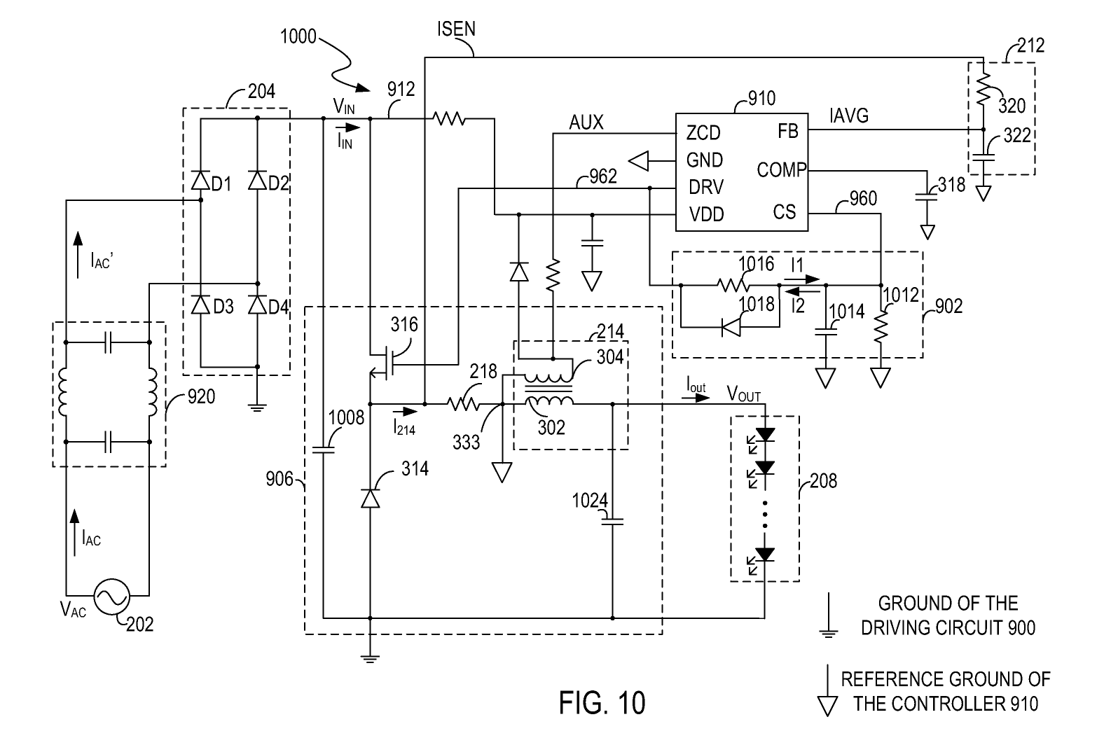

FIG. 10 shows an example for a schematic diagram of a driving circuit 1000, in an embodiment according to the present invention. Elements labeled the same as in FIG. 2, FIG. 3 and FIG. 9A have similar functions. FIG. 10 is described in combination with FIG. 4, FIG. 5 and FIG. 9A.

In the example of FIG. 10, the driving circuit 1000 includes a current filter 920 coupled to a power source 202, a rectifier 204, a power converter 906, a load 208, a saw-tooth signal generator 902, and a controller 910. In one embodiment, the load 208 includes an LED light source such as an LED string. This invention is not so limited; the load 208 can include other types of light sources or other types of loads such as a battery pack. The current filter 920 can be, but is not limited to, an inductor-capacitor (L-C) filter including a pair of inductors and a pair of capacitors. In one embodiment, the controller 910 includes multiple terminals such as a ZCD terminal, a GND terminal, a DRV terminal, a VDD terminal, an FB terminal, a COMP terminal, and a CS terminal.

In one embodiment, the power converter 906 includes an input capacitor 1008 coupled to the power line 912. The input capacitor 1008 reduces ripples of the rectified AC voltage V_{IN} to smooth the waveform of the rectified AC voltage V_{IN}. In one embodiment, the capacitor 1008 has a relatively small capacitance, e.g., less than 0.5 μF, to help eliminate or reduce any distortion of the rectified AC voltage V_{IN}. Moreover, in one embodiment, a current flowing through the capacitor 1008 can be ignored due to the relatively small capacitance. Thus, the current I_{IN} flowing through the switch 316 is approximately equal to the current from the rectifier 204 when the switch 316 is on.

The power converter 906 operates similarly as the power converter 206 in FIG. 3. In one embodiment, the energy storage element 214 includes inductors 302 and 304 magnetically and electrically coupled with each other. The inductor 302 is coupled to the switch 316 and the LED light source 208. Thus, a current I₂₁₄ flows through the inductor 302 according to the conductance status of the switch 316. More specifically, in one embodiment, the controller 910 generates the driving signal 962, e.g., a PWM signal, through the DRV terminal to switch the switch 316 to an ON state or an OFF state. When the switch 316 is turned on, the current I₂₁₄ flows from the power line 912 through the switch 316 and the inductor 302. The current I₂₁₄ increases during the ON state of the switch 316, which can be given according to equation (1):

ΔI₂₁₄=(V_{IN}−V_{OUT})*T_{ON}/L₃₀₂, (1)

where T_{ON} represents a time duration when the switch 316 is turned on, ΔI₂₁₄ represents a change of the current I₂₁₄, and L₃₀₂ represents the inductance of the inductor 302. In one embodiment, the controller 920 controls the driving signal 962 to maintain the time duration T_{ON} constant. Therefore, the change ΔI₂₁₄ of the current I₂₁₄ during the time T_{ON} is proportional to the input voltage V_{IN} if V_{OUT} is a substantially constant. In one embodiment, the switch 316 is turned on when the current I₂₁₄ decreases to a predetermined level, e.g., zero ampere. Accordingly, the peak level of the current I₂₁₄ is proportional to the input voltage V_{IN}.

When the switch 316 is turned off, the current I₂₁₄ flows from the ground through the diode 314 and the inductor 302 to the LED light source 208. Accordingly, the current I₂₁₄ decreases according to equation (2):

ΔI₂₁₄=(−V_{OUT})*T_{OFF}/L₃₀₂. (2)

Thus, the current I_{IN} is substantially equal to the current I₂₁₄ during an ON state of the switch 316 and equal to zero ampere during an OFF state of the switch 316, in one embodiment.

The inductor 304 senses an electrical condition of the inductor 302, e.g., whether the current flowing through the inductor 302 decreases to a predetermined level (e.g., zero ampere). As discussed in relation to FIG. 5, the detection signal AUX has a negative level when the switch 316 is turned on, and has a positive level when the switch 316 is turned off, in one embodiment. When the current I₂₁₄ through the inductor 302 decreases to a predetermined current level, a negative-going edge occurs to the voltage of the signal AUX. The ZCD terminal of the controller 910 coupled to the inductor 304 is used to receive the detection signal AUX.

In one embodiment, the power converter 906 includes an output filter 1024. The output filter 1024 can be a capacitor having a relatively large capacitance, e.g., greater than 400 μF. As such, the current I_{OUT} through the LED light source 208 represents an average level of the current I₂₁₄.

The current sensor 218 generates a current sense signal ISEN indicating the current flowing through the inductor 302. In one embodiment, the signal filter 212 is a resistor-capacitor (RC) filter including a resistor 320 and a capacitor 322. The signal filter 212 removes ripples of the current sense signal ISEN to generate an average sense signal IAVG of the current signal ISEN. Thus, in the example of FIG. 10, the average sense signal IAVG indicates the current I_{OUT} flowing through the LED light source 208. The terminal FB of the controller 910 receives the sense signal IAVG, in one embodiment.

The saw-tooth signal generator 902 coupled to the DRV terminal and the CS terminal is operable for generating a saw-tooth signal 960 at the CS terminal according to the driving signal 962 on the DRV terminal. By way of example, the saw-tooth signal generator 902 includes a resistor 1016 and a diode 1018 coupled in parallel between the terminal DRV and the terminal CS, and further includes a resistor 1012 and a capacitor 1014 coupled in parallel between the CS terminal and ground. In operation, the saw-tooth signal 960 varies according to the driving signal 962. More specifically, in one embodiment, the driving signal 962 is a PWM signal. When the driving signal 962 is logic high, a current I1 flows from the DRV terminal through the resistor 1016 to the capacitor 1014. Thus, the capacitor 1014 is charged and a voltage V₉₆₀ of the saw-tooth signal 960 increases. When the driving signal 962 is logic low, a current I2 flows from the capacitor 1014 through the diode 1018 to the DRV terminal. Thus, the capacitor 1014 is discharged and the voltage V₉₆₀ decreases to zero volts. The saw-tooth signal generator 902 can include other components and is not limited to the example shown in FIG. 10.

In one embodiment, the controller 910 is integrated on an integrated circuit (IC) chip. The resistors 1016 and 1012, the diode 1018, and the capacitor 1014 are peripheral components to the IC chip. Alternatively, the saw-tooth signal generator 902 and the controller 910 are both integrated on a single IC chip. In this condition, the terminal CS can be removed, which further reduces the size and the cost of the driving circuit 1000. The power converter 906 can have other configurations and is not limited to the example in FIG. 10.

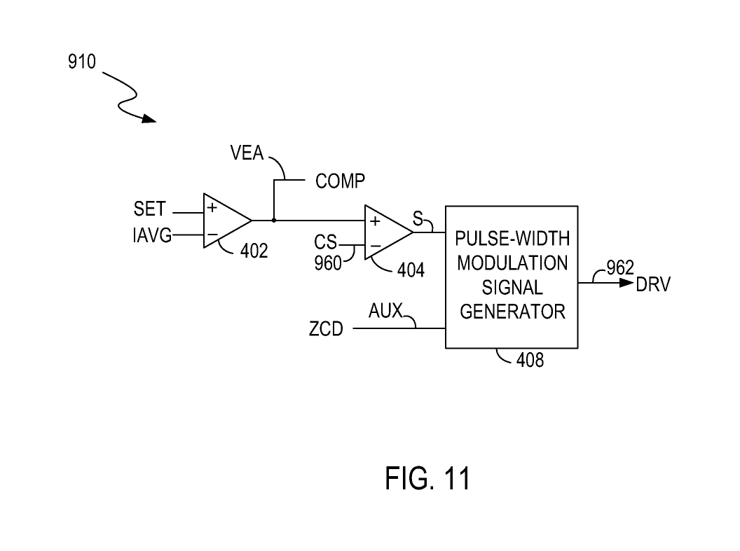

FIG. 11 shows an example of the controller 910 in FIG. 9A, in an embodiment according to the present invention. Elements labeled the same as in FIG. 4 and FIG. 9A have similar functions. FIG. 11 is described in combination with FIG. 4, FIG. 5, FIG. 9A and FIG. 10.

In one embodiment, the controller 910 has similar configurations as the controller 210 in FIG. 4, except that the CS terminal receives the saw-tooth signal 960 instead of the current sense signal ISEN. The controller 910 generates the driving signal 962 according to the signals including the saw-tooth signal 960, the sense signal IAVG, and the detection signal AUX. The controller 910 includes an error amplifier 402, a comparator 404, and a pulse-width modulation (PWM) signal generator 408. The error amplifier 402 amplifies a difference between the sense signal IAVG and a reference signal SET indicating a target current level to generate the error signal VEA. The comparator 404 compares the saw-tooth signal 960 to the error signal VEA to generate a comparing signal S. The PWM signal generator 408 generates the driving signal 962 according to the comparing signal S and the detection signal AUX.

In one embodiment, the driving signal 962 has a first level, e.g., logic high, to turn on the switch 316 when the detection signal AUX indicates that the current I₂₁₄ through the inductor 302 drops to a predetermined level, e.g., zero ampere. The driving signal 962 has a second level, e.g., logic low, to turn off the switch 316 when the saw-tooth signal 960 reaches the error signal VEA. Advantageously, since the CS terminal receives the saw-tooth signal 960 instead of the sense signal ISEN, a peak level of the current I₂₁₄ through the inductor 302 is not limited by the error signal VEA. Thus, the current I₂₁₄ through the inductor 302 varies according to the input voltage V_{IN} as shown in equation (1). For example, the peak level of the current I₂₁₄ is adjusted to be proportional to the input voltage V_{IN} instead of the error signal VEA.

The controller 910 controls the driving signal 962 to maintain the current I_{OUT} at a target current level represented by the reference signal SET. For example, if the current I_{OUT} is greater than the target level, e.g., due to the variation of the input voltage V_{IN}, the error amplifier 402 decreases the error signal VEA to shorten the time duration T_{ON} of the ON state of the switch 316. Therefore, the average level of the current I₂₁₄ is decreased to decrease the current I_{OUT}. Likewise, if the current I_{OUT} is less than the target level, the controller 910 lengthens the time duration T_{ON} to increase the current I_{OUT}.

FIG. 12 illustrates a waveform of signals generated or received by a driving circuit, e.g., the driving circuit 900 or 1000, in an embodiment according to the present invention. FIG. 12 is described in relation to FIG. 4, FIG. 9A, FIG. 9B, and FIG. 10. FIG. 12 shows the rectified AC voltage V_{IN}, the rectified AC current I_{IN}, the average current I_{IN}_{_{—}}_{AVG} of the current I_{IN}, the current I_{OUT} flowing through the LED light source 208, the sense signal ISEN indicating the current I₂₁₄ flowing through the inductor 302, the error signal VEA, the saw-tooth signal 960, and the driving signal 962.

As shown in the example of FIG. 12, the input voltage V_{IN} is a rectified sinusoidal waveform. At time t1, the driving signal 962 is changed to logic high. Thus, the switch 316 is turned on and the sense signal ISEN indicating the current I₂₁₄ through the inductor 302 increases. Meanwhile, the saw-tooth signal 960 increases according to the driving signal 962.

At time t2, the saw-tooth signal 960 reaches the error signal VEA. Accordingly, the controller 910 adjusts the driving signal 962 to logic low. The saw-tooth signal 960 drops to zero volts. The driving signal 962 turns off the switch 316, thereby decreasing the sense signal ISEN. In other words, the saw-tooth signal 960 and the error signal VEA determine the time period T_{ON} when the driving signal 962 is logic high to turn on the switch 316.

At time t3, the current I₂₁₄ decreases to the predetermined current level, e.g., zero ampere. Thus, the controller 910 adjusts the driving signal 962 to logic high to turn on the switch 316.

In one embodiment, the current I_{OUT} flowing through the LED light source 208 is equal to or proportional to an average level of the current I₂₁₄ over a cycle period of the input voltage V_{IN}. As described in relation to FIG. 11, the current I_{OUT} is adjusted to the target current level represented by the reference signal SET. In addition, as shown in FIG. 12, the sense signal ISEN indicating the current I₂₁₄ between t1 and t4 has same waveforms as those between t5 and t6. Thus, the average level of the current I₂₁₄ between t1 and t4 is equal to the average level of the current I₂₁₄ between t5 and t6. Accordingly, the current I_{OUT} is maintained at the target level. In one embodiment, the time period T_{ON} is determined by the saw-tooth signal 960 and the error signal VEA. In one embodiment, the time period T_{ON} is constant because the time period for the saw-tooth signal 960 to rise from zero volts to the error signal VEA is the same in each cycle of the driving signal 962. Based on equation (1), the change ΔI₂₁₄ of the current I₂₁₄ during the time period T_{ON} is proportional to the input voltage V_{IN}. Therefore, the peak level of the sense signal ISEN is proportional to the input voltage V_{IN} as shown in FIG. 12.

The current I_{IN} has a waveform similar to the waveform of the current I₂₁₄ when the switch 316 is turned on, and is substantially equal to zero ampere when the switch 316 is turned off, in one embodiment. The average current I_{IN}_{_{—}}_{AVG} is substantially in phase with the input voltage V_{IN} between time t1 and t6. As described in relation to FIG. 9B, the AC input current I_{AC} is substantially in phase with the AC input voltage V_{AC}, which corrects the power factor of the driving circuit 900 to improve the power quality.

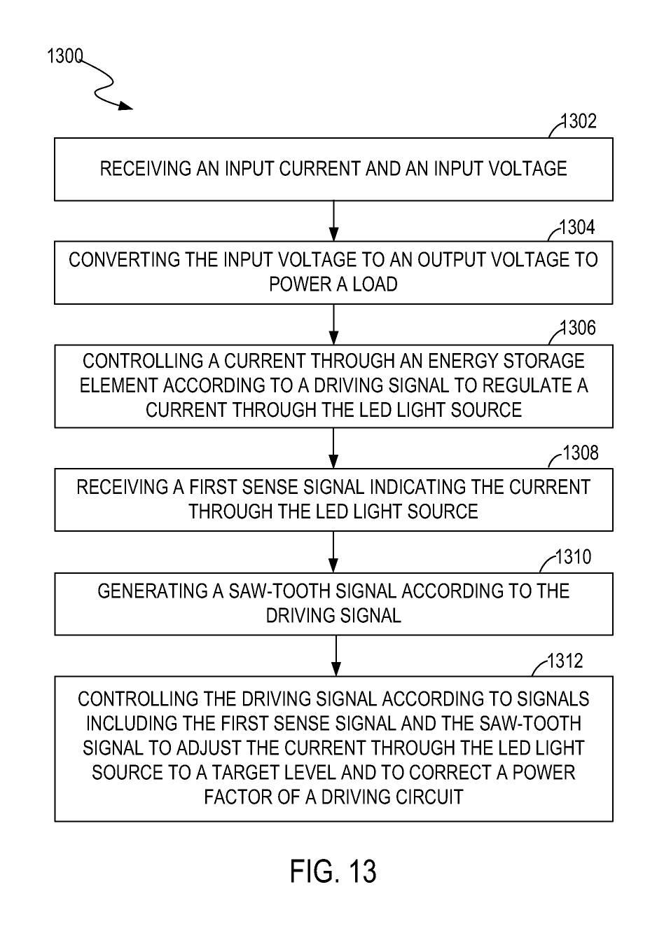

FIG. 13 illustrates a flowchart 1300 of operations performed by a circuit for driving a load, e.g., the circuit 900 or 1000 for driving an LED light source 208, in an embodiment according to the present invention. FIG. 13 is described in combination with FIG. 9A-FIG. 12. Although specific steps are disclosed in FIG. 13, such steps are examples. That is, the present invention is well suited to performing various other steps or variations of the steps recited in FIG. 13.

In block 1302, an input voltage, e.g., the rectified AC voltage V_{IN}, and an input current, e.g., the rectified AC current I_{IN}, are received. In block 1304, the input voltage is converted to an output voltage to power a load, e.g., an LED light source. In block 1306, a current flowing through an energy storage element, e.g., the energy storage element 214, is controlled according to a driving signal, e.g., the driving signal 962, so as to regulate a current through said LED light source.

In block 1308, a first sense signal, e.g., IAVG, indicating the current through said LED light source is received. In one embodiment, the first sense signal is generated by filtering a second sense signal indicating the current through the energy storage element. In block 1310, a saw-tooth signal is generated based on the driving signal.

In block 1312, the driving signal is controlled based on signals including the saw-tooth signal and the first sense signal to adjust the current through the LED light source to a target level and to correct a power factor of the driving circuit by controlling an average current of the input current to be substantially in phase with the input voltage. In one embodiment, an error signal indicating a difference between the first sense signal and a reference signal indicating the target level of the current through the LED light source is generated. The saw-tooth signal is compared to the error signal. A detection signal indicating an electric condition of the energy storage element is received. The driving signal is switched to a first state if the detection signal indicates that the current through the energy storage element decreases to a predetermined level and is switched to a second state according to a result of the comparison of the saw-tooth signal and the error signal. The current through the energy storage element is increased when the driving signal is in the first state and is decreased when the driving signal is in the second state. In one embodiment, a time duration for the saw-tooth signal to increase from a predetermined level to the error signal is constant if the current through the LED light source is maintained at the target level.

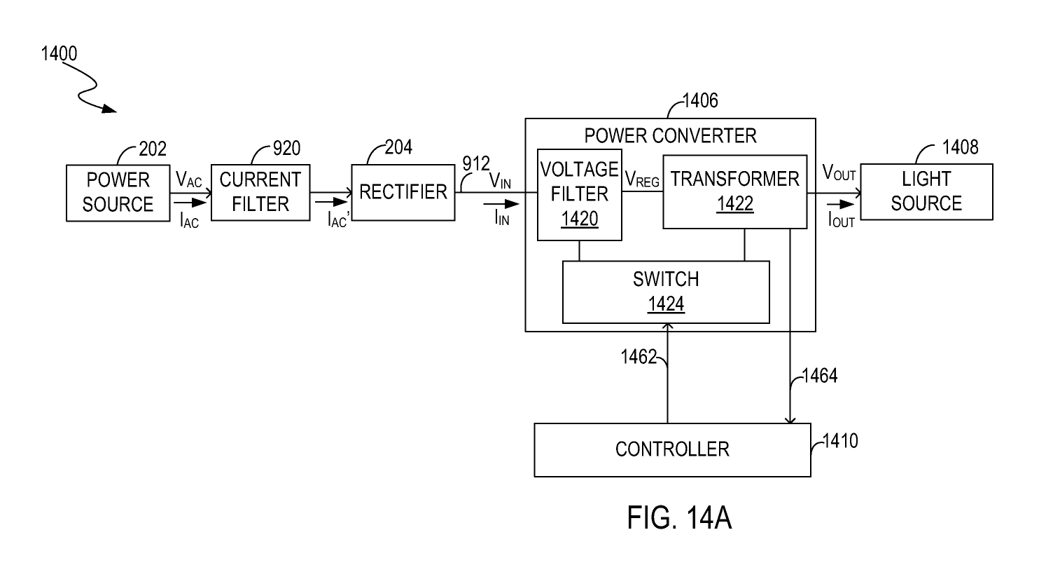

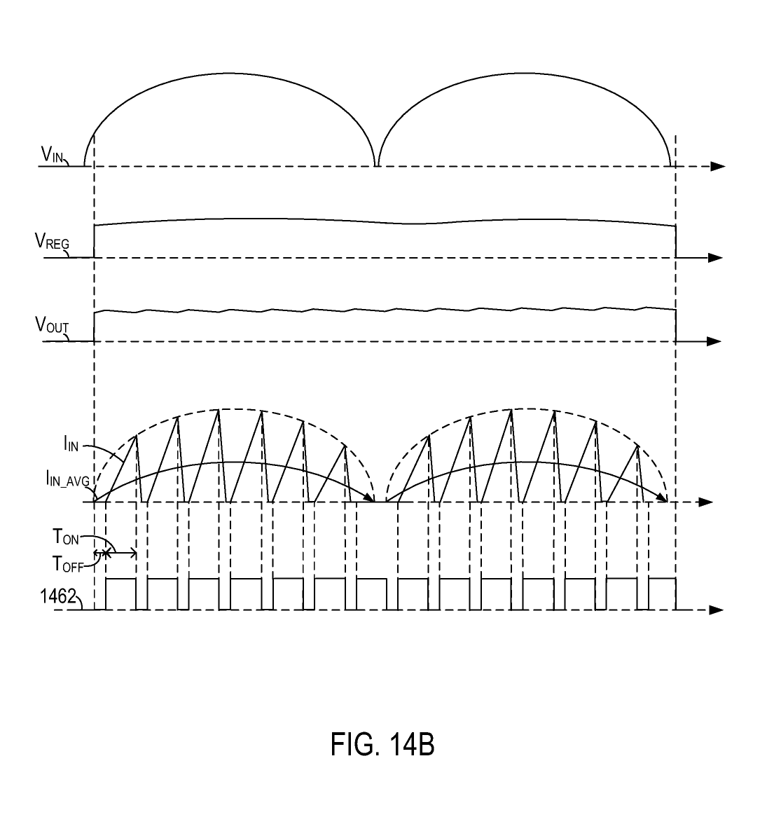

FIG. 14A shows another block diagram of a driving circuit 1400, in an embodiment according to the present invention. Elements labeled the same as in FIG. 2, FIG. 3, and FIG. 9A have similar functions. FIG. 14B illustrates a waveform of signals generated or received by the driving circuit 1400 in an embodiment according to the present invention. FIG. 14A and FIG. 14B are described in combination with FIG. 9A and FIG. 9B.

In the example of FIG. 14A, the driving circuit 1400 includes a current filter 920 coupled to a power source 202, a rectifier 204, a power converter 1406, a light source 1408, and a controller 1410. The power source 202 generates an AC input voltage V_{AC} having, e.g., a sinusoidal waveform, and an AC input current I_{AC}. The AC input current I_{AC} flows into the current filter 920, and a current I_{AC}′ flows from the current filter 920 to the rectifier 204. The rectifier 204 receives the AC input voltage V_{AC} via the current filter 920 and provides a rectified AC voltage V_{IN} and a rectified AC current I_{IN} at the power line 912 coupled between the rectifier 204 and the power converter 1406.

In one embodiment, the power converter 1406 includes a voltage filter 1420, a transformer 1422, and a switch 1424. The voltage filter 1420 receives the voltage V_{IN}, and filters the voltage V_{IN} to generate a regulated voltage V_{REG}. For example, relatively high frequency harmonic components of the voltage V_{IN} are excluded or removed. Thus, as shown in FIG. 14B, the waveform of the regulated voltage V_{REG} is more stable than the waveform of the voltage V_{IN}. The transformer 1422 converts the regulated voltage V_{REG} to an output voltage V_{OUT} to power the light source 1408. Thus, the waveform of the output voltage V_{OUT} is not affected by the variations of the input voltage V_{IN}, e.g., a sinusoidal waveform. Accordingly, ripples of the current I_{OUT} flowing through the light source 1408 caused by variations of the input voltage V_{IN} are reduced or eliminated, which further reduces the line frequency interferences for the light emitted by the light source 1408.

The controller 1410 generates a driving signal 1462 to operate the switch 1424 in a first state or a second state, which further controls an input current I_{IN} flowing into the filter 1420 and controls an output current I_{OUT} flowing through the light source 1408. In one embodiment, the transformer 1422 provides a sense signal 1464 indicating the output current I_{OUT}. Based on the sense signal 1464, the controller 1410 controls a ratio of the time period T_{ON} to the time period T_{OFF} of the switch 1424 to adjust the current I_{OUT} to a target level.

In one embodiment, the input current I_{IN} increases during operation in the first state of the switch 1424 and decreases during operation in the second state of the switch 1424. The controller 1410 controls a time duration of the second state to allow the input current I_{IN} to decrease to a predetermined level, e.g., ground, during operation in the second state. The controller 1410 further controls a time duration of the first state to allow the input current to increase from said predetermined level to a level proportional to the input voltage V_{IN}. An average current I_{IN}_{_{—}}_{AVG} of the current I_{IN} is substantially in phase with the input voltage V_{IN} accordingly. Similar to the discussion in relation to FIG. 9B, the current I_{AC} is substantially in phase with the input voltage V_{AC}. Ideally, the AC input voltage V_{AC} and the AC input current I_{AC} are in phase. However, in practical application, there might be a slight phase difference due to capacitors in the current filter 920 and the power converter 1406. Moreover, the shape of the waveform of the input AC current I_{AC} is similar to the shape of the waveform of the input AC voltage V_{AC}. Therefore, the power factor of the circuit 1400 is corrected.

Advantageously, by switching the single switch 1424 between the first state and the second state, the power factor of the circuit 1400 is corrected and the output current I_{OUT} is adjusted to the target level. Thus, both the power quality of the circuit 1400 and the accuracy of the current control are improved. As only the single switch 1424 is employed for the control, the size and the cost of the circuit 1400 are reduced.

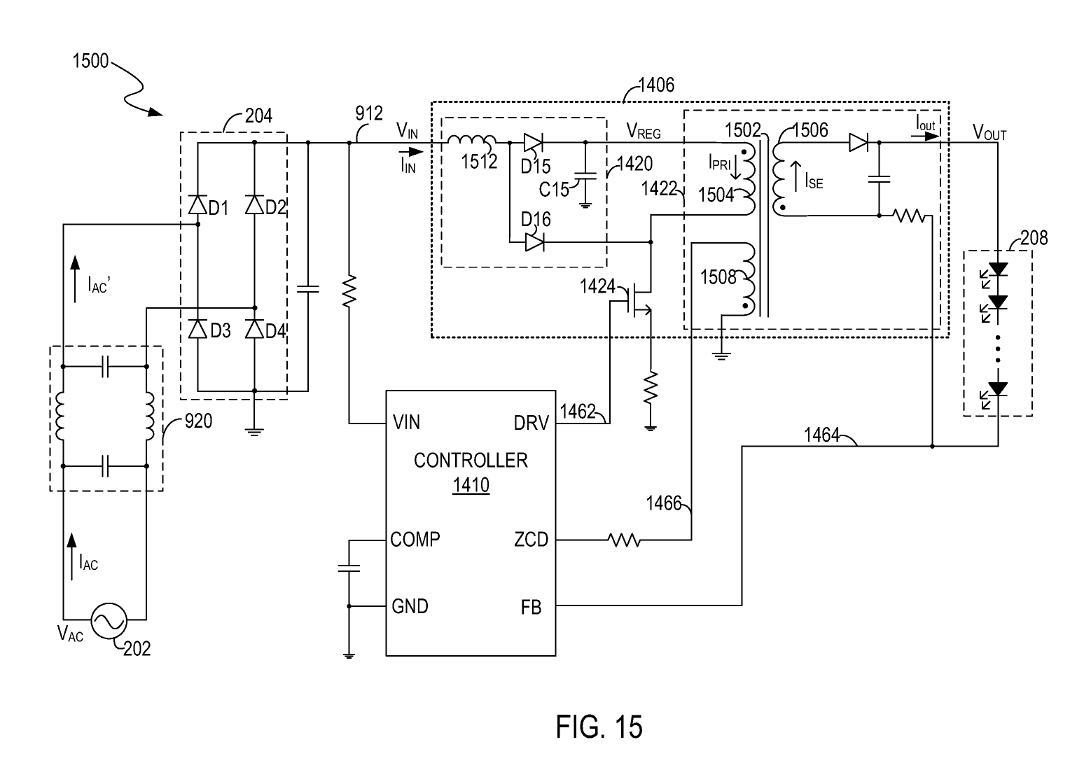

FIG. 15 shows an example schematic diagram of a driving circuit 1500, in an embodiment according to the present invention. Elements labeled the same as in FIG. 2, FIG. 3, FIG. 9A, and FIG. 14A have similar functions. FIG. 15 is described in combination with FIG. 14A and FIG. 14B. In one embodiment, the controller 1410 includes multiple pins such as a VIN pin, a COMP pin, a GND pin, a DRV pin, a CS pin, a VDD pin, a ZCD pin, and an FB pin.

In one embodiment, the voltage regulator 1420 includes an inductor 1512, diodes D15 and D16, and a capacitor C15. The transformer 1422 can be a flyback converter including a primary winding 1504, a secondary winding 1506, an auxiliary winding 1508, and a core 1502. The switch 1424 is coupled to the diode D16 and the primary winding 1504, and operates in the first state, e.g., an ON state, and the second state, e.g., an OFF state, to control the current I_{IN} flowing through the inductor 1512 and to control the current I_{OUT} flowing through the LED light source 1408.

In one embodiment, the controller 1410 generates the driving signal 1462, e.g., a pulse-width modulation signal, to control the switch 1424. More specifically, in one embodiment, when the driving signal 1462 has a high electrical level, e.g., during an ON time T_{ON}, the switch 1424 is turned on, the diode D15 is reverse biased, and the diode D16 is forward biased. The transformer 1422 is powered by the regulated voltage V_{REG}. The current I_{PRI} flows through the primary winding 1504, the switch 1424, and ground. The current I_{PRI} increases to store energy to the core 1502. Moreover, the current I_{IN} flows through the inductor 1512, the diode D16, and the switch 1424, and increases to charge the inductor 1512, which can be given as equation (3):

ΔI_{IN}=V_{IN}*T_{CH}/L₁₅₁₂, (3)

where T_{CH} represents a charging time when the inductor 1512 is charged during the ON state of the switch 1424, ΔI_{IN} represents a change of the current I_{IN}, and L₁₅₁₂ represents the inductance of the inductor 1512. In one embodiment, the time duration T_{CH} is equal to the time duration T_{ON} when the switch 1424 is turned on.

When the driving signal 1462 has a low electrical level, e.g., during an OFF time T_{OFF}, the switch 1424 is turned off, the diode D15 is forward biased, and the diode D16 is reverse biased. The transformer 1422 is discharged to power the LED light source 208. Therefore, the current I_{SE} flowing through the secondary winding 1506 decreases. Moreover, the current I_{IN} flows through the inductor 1512, the diode D15, and the capacitor C15, and decreases according to equation (4) to discharge the inductor 1512:

ΔI_{IN}=(V_{IN}−V_{REG})*T_{DISCH}/L₁₅₁₂. (4)

where T_{DISCH} represents a time duration when the inductor 1512 is discharged during the OFF state of the switch 1424. Since the discharging of the inductor 1512 is terminated once the current I_{IN} decreases to zero ampere, the time duration T_{DISCH} can be different from the time period T_{OFF} for the OFF state.

In one embodiment, the inductor 1512 and the capacitor C15 constitute an inductor-capacitor (LC) filter. The LC filter filters out the high frequency harmonic components of the voltage V_{IN}. As such, ripples of the waveform of the regulated voltage V_{REG} caused by the variations of the voltage V_{IN} is reduced. The transformer 1422 converts the regulated voltage V_{REG} to the output voltage V_{OUT}, which is also independent of the voltage V_{IN}.

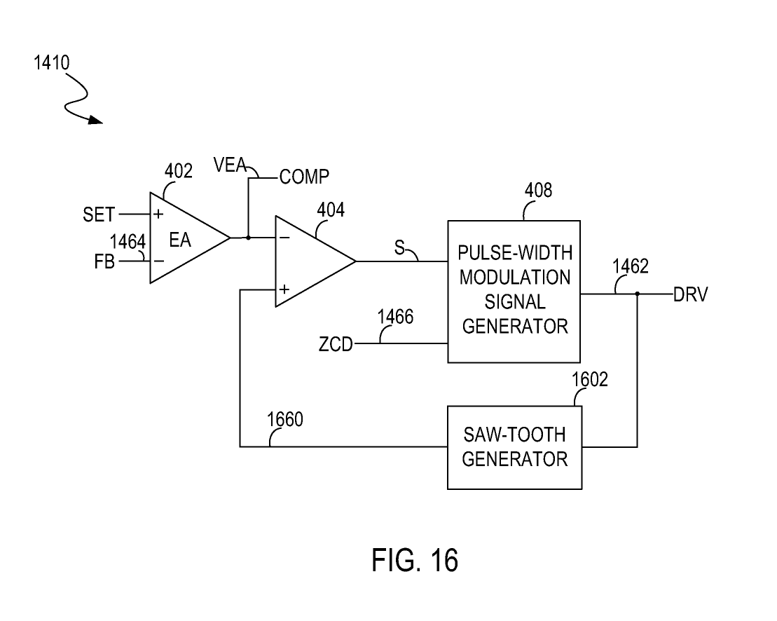

In one embodiment, the auxiliary winding 1508 is coupled to the controller 1410 via the ZCD pin. The auxiliary winding 1508 provides a current detection signal 1466 indicating whether the current I_{SE} drops to the predetermined level, e.g., zero ampere. The FB pin of the controller 1410 receives a sense signal 1464 indicating the current I_{OUT} flowing through the LED light source 208. In one embodiment, the controller 1410 controls a duty cycle of the driving signal 1462 based on signals including the current detection signal 1466 and the sense signal 1464 to adjust the current I_{OUT} to the target current level. The operation of the controller 1410 is further described in relation to FIG. 16.

In one embodiment, the controller 1410 further controls the time durations T_{ON} and T_{OFF} of the driving signal 1462 to correct a power factor of the circuit 1500. More specifically, in one embodiment, the controller 1410 sets the time duration T_{OFF} of the OFF state to be greater than a time threshold T_{TH}. By rewriting the equation (4), the discharging time of the inductor 1512 can be given by:

T_{DISCH}=ΔI_{N}*L₁₅₁₂/(V_{IN}−V_{REG}). (5)

As shown in FIG. 14B, ΔI_{IN} can be different in different cycle periods of the driving signal 1462. In one embodiment, the time threshold T_{TH} can be set to an amount equal to or greater than a maximum discharging time T_{DISCH}_{_{—}}_{MAX} of the inductor 1512. As such, the time duration of the OFF state of the switch 1424 is sufficient to allow the current I_{IN} to decrease to zero ampere. Moreover, the controller 1410 maintains the time duration T_{ON} at a same value. Thus, according to equation (3), the current I_{IN} increases from the predetermined level to the peak level proportional to the input voltage V_{IN}. Therefore, as described in relation to FIG. 14A and FIG. 14B, the power factor of the circuit 1500 is corrected to improve the power quality of the circuit 1500.

FIG. 16 shows an example of the controller 1410 in FIG. 14A, in an embodiment according to the present invention. Elements labeled the same as in FIG. 4 and FIG. 9A have similar functions. FIG. 16 is described in combination with FIG. 4, FIG. 5, FIG. 10, and FIG. 11.

In one embodiment, the controller 1410 has a similar configuration as the controller 910 in FIG. 11, except that the controller 1410 further includes a saw-tooth signal generator 1602 that generates a saw-tooth signal 1660. In one embodiment, the saw-tooth generator 1402 operates similarly as the saw-tooth generator 902 shown in FIG. 10. The saw-tooth signal 1660 ramps up when the driving signal 1462 turns on the switch 1424 and drops to zero ampere when the driving signal 1462 turns off the switch 1424.

The controller 1410 generates the driving signal 1462 according to the signals including the saw-tooth signal 1660, the sense signal 1464, and the detection signal 1466. The controller 1410 further includes an error amplifier 402, a comparator 404, and a pulse-width modulation (PWM) signal generator 408. The error amplifier 402 amplifies a difference between the sense signal 1464 and a reference signal SET indicating a target current level to generate the error signal VEA. The comparator 404 compares the saw-tooth signal 1660 to the error signal VEA to generate a comparing signal S. The PWM signal generator 408 generates the driving signal 1462 according to the comparing signal S and the detection signal AUX. T_{ON} corresponds to the amount of time it takes for a saw-tooth signal 1660 to increase from a predetermined level to the error signal VEA.

In one embodiment, the driving signal 1462 can have a high electrical level to turn on the switch 1424 when the detection signal 1466 indicates that the current I_{SE} through the secondary winding 1506 drops to a predetermined level, e.g., zero ampere. The driving signal 1462 can also have a low electrical level to turn off the switch 1424 when the saw-tooth signal 1460 reaches the error signal VEA.

The controller 1410 controls the driving signal 1462 to maintain the current I_{OUT} at a target current level represented by the reference signal SET. For example, if the current I_{OUT} is greater than the target level, e.g., due to undesirable noise, the error amplifier 402 decreases the error signal VEA to shorten the time duration T_{ON} of the ON state of the switch 316. Therefore, the duty cycle of the driving signal 1462 is decreased to decrease the current I_{OUT}. Likewise, if the current I_{OUT} is less than the target level, the controller 1410 increases the duty cycle of the driving signal 1462 to increase the current I_{OUT}. In one embodiment, if the current I_{OUT} is maintained at the target level, then the time duration T_{ON} is maintained at a constant value.

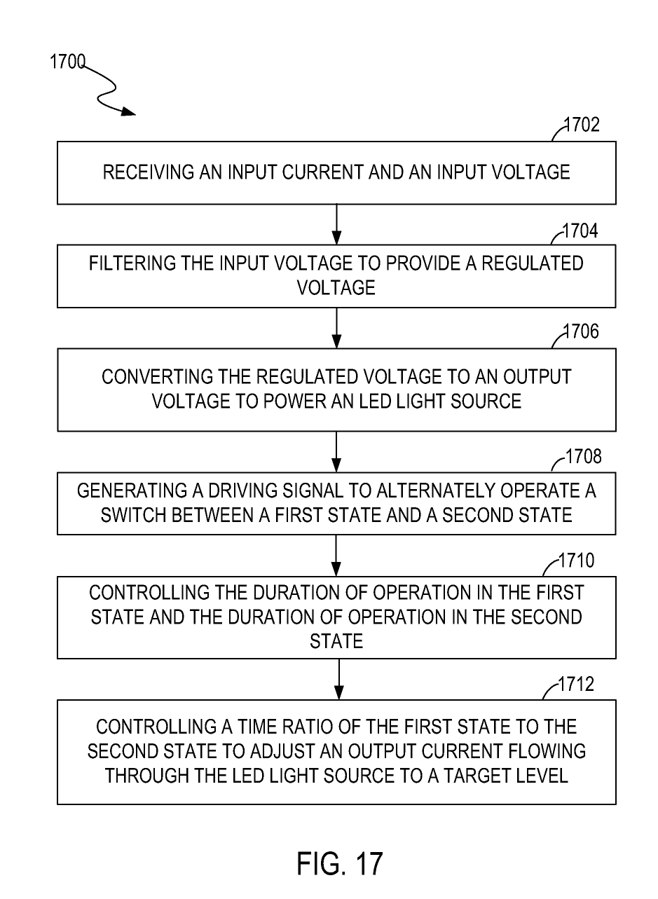

FIG. 17 illustrates a flowchart 1700 of examples of operations performed by a circuit for driving a light source 1408, in an embodiment according to the present invention. FIG. 17 is described in combination with FIG. 14A-FIG. 16. Although specific steps are disclosed in FIG. 17, such steps are examples. That is, the present invention is well suited to performing various other steps or variations of the steps recited in FIG. 17.

In block 1702, an input current, e.g., the input current I_{IN}, and an input voltage, e.g., the input voltage V_{IN}, are received. In block 1704, the input voltage is filtered to provide a regulated voltage, e.g., the regulated voltage V_{REG}. In block 1706, the regulated voltage is converted to an output voltage, e.g., the output voltage V_{OUT}, to power the LED light source. In block 1708, a driving signal, e.g., the driving signal 1462, is generated to alternately operate a switch, e.g., the switch 1424, between a first state and a second state. The input current is increased during the first state and is decreased during the second state.

In block 1710, the duration of operation in the first state and the duration of operation in the second state are controlled, such that the input current decreases to a predetermined level, e.g., zero ampere, during operation in the second state and increases from the predetermined level to a peak level proportional to the input voltage during operation in the first state.

In block 1712, a time ratio—the ratio of the amount of time in the first state to the amount of time in the second state—is controlled to adjust the output current flowing through the LED light source to a target level.

Embodiments in accordance with the present invention provide a driving circuit for driving a load, e.g., an LED light source. The driving circuit includes a filter, a transformer, and a controller. The filter receives an input voltage and filters the input voltage to provide a regulated voltage. The transformer converts the regulated voltage to an output voltage to power the LED light source. The controller generates a driving signal to alternately operate a switch between a first state and a second state. The controller controls the duration of operation in the first state and the duration of operation in the second state, such that the input current decreases to a predetermined level during operation in the second state and increases from the predetermined level to a peak level proportional to the input voltage during operation in the first state. The controller further controls a time ratio (time in the first state to time in the second state) to adjust an output current flowing through the LED light source to a target level. Advantageously, ripples of the output current flowing through the LED light source caused by variations of the input voltage are reduced or eliminated, which further reduces the line frequency interferences for the light emitted by the light source. Moreover, the power factor of the driving circuit is corrected to improve the power quality of the driving circuit and the accuracy of the current control of the driving circuit is also improved.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A circuit for powering a light-emitting diode (LED) light source, said circuit comprising:
a filter that receives an input voltage and that filters said input voltage to provide a regulated voltage;
a transformer, coupled to said filter, that converts said regulated voltage to an output voltage to power said LED light source; and
a controller, coupled to a switch that is further coupled to said filter and said transformer, that generates a driving signal to alternately operate said switch between a first state and a second state, wherein an input current flowing through said filter is increased during said first state and is decreased during said second state,
wherein said controller controls the duration of operation in said first state and the duration of operation in said second state, such that said input current decreases to a predetermined level during operation in said second state and increases from said predetermined level to a peak level proportional to said input voltage during operation in said first state,
wherein said controller controls the ratio of time in said first state to time in said second state to adjust an output current flowing through said LED light source to a target level.

2. The circuit as claimed in claim 1, wherein said filter comprises:
an inductor coupled to said switch through a first diode and coupled to a capacitor through a second diode,
wherein said input current flows through said inductor, said first diode, and said switch during operation in said first state, and flows through said inductor, said second diode, and said capacitor during said operation in second state.

3. The circuit as claimed in claim 2, wherein said inductor and said capacitor constitute an inductor-capacitor (LC) filter that filters out a plurality of harmonic components of said input voltage to generate said regulated voltage.

4. The circuit as claimed in claim 1, wherein said transformer comprises:
a primary winding that receives said regulated voltage; and
a secondary winding that provides said output voltage to said LED light source,
wherein a current flowing through said primary winding and said switch increases during operation in said first state and a current flowing through said secondary winding decreases during operation in said second state.

5. The circuit as claimed in claim 1, wherein said time duration of operation in said first state is sufficient to allow said input current to rise from said predetermined level to said level proportional to said input voltage.

6. The circuit as claimed in claim 1, wherein said time duration of operation in said second state is sufficient to allow said input current to decrease to said predetermined level.

7. The circuit as claimed in claim 1, wherein said controller comprises:
a generator that generates saw-tooth signals according to said driving signal;
an error amplifier generating an error signal based on a sense signal indicating said output current through said LED light source and based on a reference signal indicating said target level of said output current; and
a comparator, coupled to said error amplifier, that compares said saw-tooth signal with said error signal to control said driving signal.

8. The circuit as claimed in claim 7, wherein a saw-tooth signal increases during said first state of said switch, and wherein said switch is switched to said second state when said saw-tooth signal reaches said error signal.

9. The circuit as claimed in claim 8, wherein time durations for said saw-tooth signals to increase from a predetermined level to said error signal are constant if said current through said LED light source is maintained at said target level.

10. The circuit as claimed in claim 1, further comprising:
a rectifier that receives an input alternating current (AC) current and an input AC voltage and provides said input current,
wherein said controller corrects said power factor such that said input AC current is substantially in phase with said input AC voltage.

11. A power converter for powering a light-emitting diode (LED) light source, said power converter comprising:
a switch operating in a first state and a second state according to a pulse signal;
a filter, coupled to said switch, comprising an inductor and a capacitor and that filters an input voltage to provide a regulated voltage; wherein during said first state an input current flows through said inductor and said switch, and said input current increases from a predetermined level to a peak level proportional to said input voltage; and wherein during said second state said input current flows through said inductor and said capacitor, and said input current decreases to said predetermined level; and
a transformer, having a primary winding coupled to said switch and having a secondary winding, that converts said regulated voltage to an output voltage to power said LED light source; wherein during said first state, said transformer is powered by said regulated voltage, and a current flowing through said primary winding and said switch increases; and wherein during said second state, said transformer is discharged to provide power to said LED light source, and a current flowing through said secondary winding decreases,
wherein a duty cycle of said pulse signal is adjusted to adjust an output current flowing through said LED light source to a target level.

12. The power converter as claimed in claim 11, wherein said transformer further comprises:
an auxiliary winding that generates a current detection signal indicating whether said current through said secondary winding decreases to a predetermined level,
wherein said switch is switched from said second state to said first state in response to said current detection signal.

13. The power converter as claimed in claim 11, wherein a time duration of said second state is greater than a time period for said input current to decrease to said predetermined level.

14. The power converter as claimed in claim 11, wherein time durations of said first state are maintained at a constant value.

15. A method for powering a light-emitting diode (LED) light source, said method comprising:
receiving an input voltage and an input current;
filtering said input voltage to provide a regulated voltage;
converting said regulated voltage to an output voltage to power said LED light source;
generating a driving signal to alternately operate a switch between a first state and a second state, wherein said input current is increased during said first state and is decreased during said second state;
controlling the duration of operation in said first state and the duration of operation in said second state, such that said input current decreases to a predetermined level during operation in said second state and increases from said predetermined level to a peak level proportional to said input voltage during operation in said first state; and
controlling the ratio of time in said first state to time in said second state to adjust an output current flowing through said LED light source to a target level.

16. The method as claimed in claim 15, further comprising:
receiving said regulated voltage by a primary winding of a transformer;
providing said output voltage to said LED light source by a secondary winding of said transformer;
increasing a current flowing through said primary winding and said switch during operation in said first state; and
decreasing a current flowing through said secondary winding during operation in said second state.

17. The method as claimed in claim 15, wherein said time duration of operation in said first state is sufficient to allow said input current to rise from said predetermined level to said level proportional to said input voltage.

18. The method as claimed in claim 15, wherein said time duration of operation in said second state is sufficient to allow said input current to decrease to said predetermined level.

19. The method as claimed in claim 15, further comprising:
generating a saw-tooth signal according to said driving signal;
generating an error signal based on a sense signal indicating said output current through said LED light source and based on a reference signal indicating said target level of said output current;
comparing said saw-tooth signal with said error signal to control said driving signal; and
switching said switch from said first state to said second state in response to said saw-tooth signal reaching said error signal.

20. The method as claimed in claim 19, wherein time durations for saw-tooth signals generated according to said driving signal to increase from a predetermined level to said error signal are constant if said current through said LED light source is maintained at said target level.
